(19) United States
(12) Patent Application Publication
(10) Pub. No.: US 2005/0105400 A1
(43) Pub. Date: May 19, 2005

(54) Electronic timepiece with analog display and a method of operating same

(76) Inventor: Tai Wai Luk, Kowloon (HK)

Correspondence Address: BURNS DOANE SWECKER & MATHIS L L P, POST OFFICE BOX 1404, ALEXANDRIA, VA, 22313-1404, US

(21) Appl. No.: 10/713,144

(22) Filed: Nov. 17, 2003

(51) Int. Cl. G04C 11/02

(52) U.S. Cl. 368/47

(57) ABSTRACT

An electric timepiece is disclosed as including a micro-controlling with a volatile RAM adapted to be written with time-related data, an EEPROM or FRAM adapted to be written with time-related data, and a stepping motor operatively associated with an analog time display, in which the time-related data in the volatile RAM and in the EEPROM or FRAM are synchronized with each other, and the micro-controller is adapted to update the time-related data in the volatile RAM and in the EPPROM or FRAM simultaneously every second.

This invention relates to an electronic timepiece with analog display, in particular, such a timepiece having a signal receiver for receiving externally transmitted time-related radio signals, and a method of operating such a timepiece.

### BACKGROUND OF THE INVENTION

U.S. Pat. No. 6,072,752 discloses a hand display-type electronic timepiece which allows a user to synchronize the hands and the timing counter. This is achieved by providing a power source voltage detecting means which monitors the voltage of the battery/electric cell at all times. A predetermined output signal is generated when the fact that the voltage of the battery has dropped below a predetermined level is detected by the power source voltage detecting means. The hand position data are written into a non-volatile memory in response to the above output signal, and the hands are stopped at the same time. When a new battery is replaced, and the timepiece resumes operation, the timepiece will obtain radio signals relating to the accurate current time from an outside source, compare it with the hand position data written into the non-volatile memory, and drive the hands to move so that the displayed time corresponds to, and is thus synchronized with, the current time.

In some very common circumstances where the battery voltage is normal but, for some reason, the battery has to be removed from the timepiece, no predetermined output signal will be generated in accordance with the arrangement disclosed in U.S. Pat. No. 6,072,752 before removal of the battery. No hand position will then be written into the non-volatile memory, in which case the above feature cannot function.

German Patent Document No. DE 195 07 543 A1 discloses a radio-controlled clock/watch with an analogue display which is enabled, by the use of a non-volatile memory with a buffer memory upstream, to return the hands, after interruptions of normal operating conditions, to the position corresponding to the broadcast signals of current time. As in the case of the electronic timepiece disclosed in U.S. Pat. No. 6,072,752, no hand position data will be written into the non-volatile memory if the interruption of operation is due to a sudden disconnection of power supply. In such a case, there is no power for the RAM to execute the backup operation, and the EEPROM will have no data to show the position of the hands before the interruption.

It is thus an object of the present invention to provide an electronic timepiece and a method of operating an electronic timepiece in which the aforesaid shortcomings are mitigated, or at least to provide a useful alternative to the public.

### SUMMARY OF THE INVENTION

According to a first aspect of the present invention, there is provided an electric timepiece including a controlling device with at least a volatile memory adapted to be stored with time-related data, a non-volatile memory adapted to be stored with time-related data, and a motor operatively associated with an analog time display, wherein said time-related data in said volatile memory and in said non-volatile memory are synchronized with each other, and wherein said controlling device is adapted to update said time-related data in said volatile memory and in said non-volatile memory simultaneously every second.

According to a second aspect of the present invention, there is provided a method of operating an electric timepiece including the steps of providing a controlling device with at least a volatile memory; providing a non-volatile memory; providing a motor operatively associated with an analog time display; writing time-related data into said volatile memory; writing time-related data into said non-volatile memory; synchronizing said time-related data in said volatile memory and in said non-volatile memory; and said controlling device updating said time-related data in said volatile memory and in said non-volatile memory simultaneously every second.

### BRIEF DESCRIPTION OF THE DRAWINGS

Preferred embodiments of the present invention will now be described, by way of examples only, with reference to the accompanying drawings, in which:

FIG. 1 shows a block diagram of a first embodiment of a timepiece according to the present invention;

FIG. 2 shows a block diagram of a second embodiment of a timepiece according to the present invention;

FIG. 3 shows a block diagram of a micro-controller (MCU) which may be used in a timepiece according to the present invention;

FIG. 4 shows a block diagram of an EEPROM which may be used as a non-volatile memory in a timepiece according to the present invention; and

FIG. 5 shows a block diagram of a FRAM which may also be used as a non-volatile memory in a timepiece according to the present invention.

### DETAILED DESCRIPTION OF THE PREFERRED EMBODIMENTS

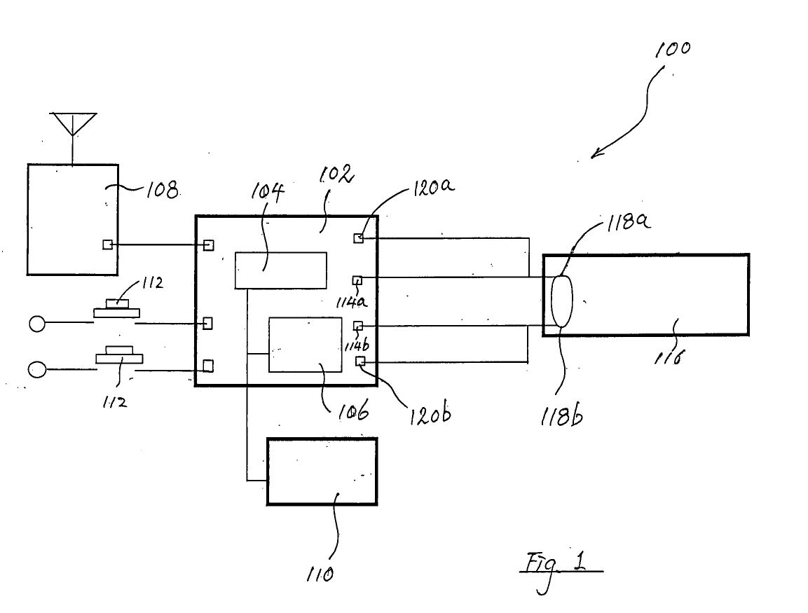

A block diagram of an electronic timepiece according to a first embodiment of the present invention is shown in FIG. 1, and generally designated as 100. The operation of the timepiece 100 is controlled by a micro-controller (MCU) 102 with a processor 104 and a volatile memory 106, e.g. a volatile RAM. The MCU 102 is connected with a radio signal receiver 108, which receives externally transmitted time-related radio signals giving the accurate current time, e.g. from a satellite. Both the processor 104 and the volatile RAM 106 of the MCU 102 are also connected with an external non-volatile memory 110, e.g. an electrically erasable programmable read-only memory (EEPROM) or a ferroelectric random access memory (FRAM).

The MCU 102 is connected with two switches 112 operable to input time-related instructions into the timepiece 100, in lieu of time-related signals received from the external source. The MCU 102 sends pulse signals, through motor drive input/output (I/O) ports 114a, 114b, to poles 118a, 118b of a stepping motor 116 to drive a mechanical time display for displaying the time in an analog manner. The MCU 102 also includes two pulse width measurement input/output (I/O) ports 120a, 120b for measuring the “width” of the pulse signals sent via the motor drive I/O ports 114a, 114b to the poles 118a, 118b of the stepping motor 116.

In the present application, mechanical time display or analog display refers to, but is not limited to, hour hand, minute hand, seconds hand, day hand, week hand, month hand, year hand, and various other kinds of mechanical display devices, e.g. panel displays at airports showing the flight arrival/departure time.

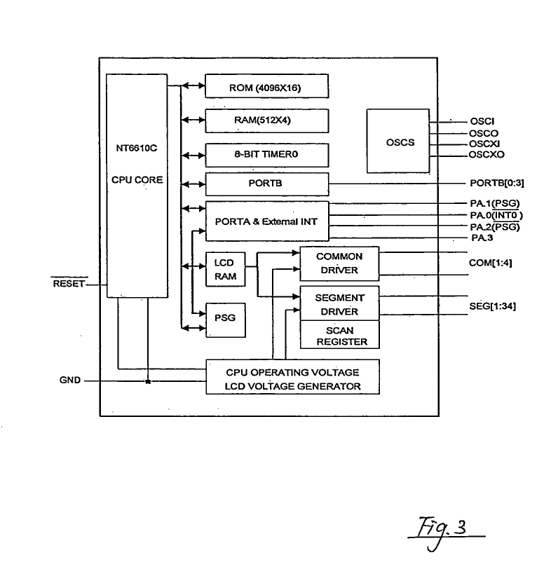

A micro-controller which may be used in the present invention may be a 4K 4-Bit micro-controller with liquid crystal display (LCD) driver manufactured and traded by Novatek Microelectronics Corp. Ltd. of Taiwan under Model No. NT6613. A block diagram of this micro-controller is shown in FIG. 3. This is a single chip micro-controller integrated with static random access memory (SRAM), timer and dual-tone PSG, LCD driver and I/O port. Table 1 below gives the pad description of this micro-controller.

TABLE 1

| Designation | I/O | Description |
|---|---|---|
| SEG1-SEG 34 | O | Segment signal output for LCD display; |
| | | Share with scans output. |
| V_{LCD}, V₁, V₂, V₃ | I | Connect with external LCD divided |
| | | resistance |
| TEST | I | Test pin (Internal pull-low). No connect for |
| | | user. |
| /RESET | I | Reset pin (No internal pull-up) |
| V_{DD} | P | Power supply. |
| Port B.3-Port B.0 | I/O | Bit programmable I/O, Vector interrupt |
| | | (/INT1) |
| Port A.3-Port A.0 | I/O | Bit programmable I/O, PA.0 shared with |
| | | /INT0 PA.1, PA.2 shared with PSG output |
| OSCXI | I | Oscillator X input pin |
| OSCXO | O | Oscillator X output pin |
| GND | P | Ground pin |
| OSCO | O | Oscillator output pin |
| OSCI | I | Oscillator input pin |
| COM1-COM4 | O | Common signal output for LCD display |

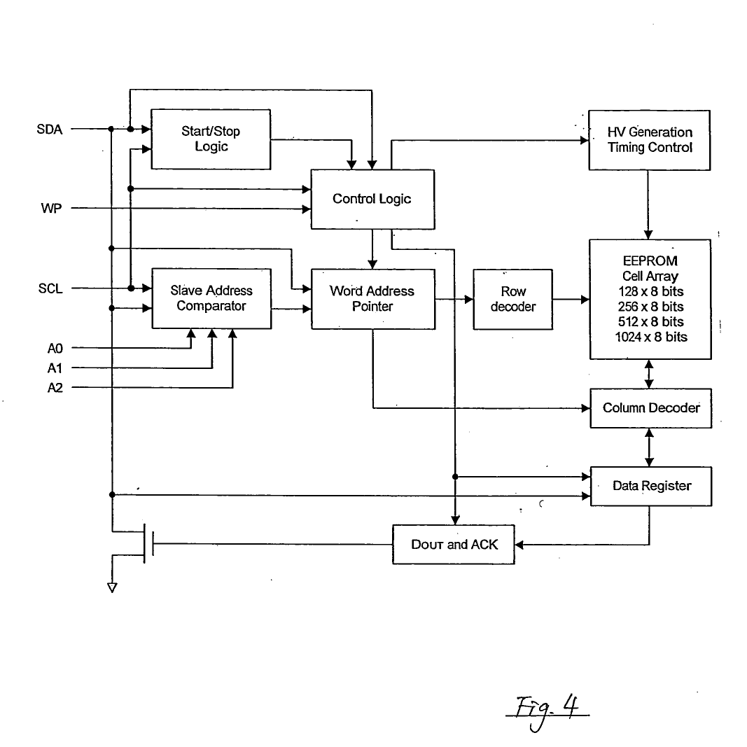

A non-volatile memory which may be used in the present invention may be an 8K-bit EEPROM manufactured and traded by Samsung Electronics of Korea under Model No. S524C80D81. A block diagram of this EEPROM is shown in FIG. 4. Table 2 below gives the pad description of this EEPROM.

TABLE 2

| Name | Type | Description |
|---|---|---|
| A0, A1, A2 | Input | Input pins for device address selection. To configure |
| | | a device address, these pins should be connected |
| | | to the V_{CC} or V_{SS} of the device. |
| V_{SS} | — | Ground pin. |
| SDA | I/O | Bi-directional data pin for the I²C ™-bus serial data |
| | | interface. Schmitt trigger input and open-drain |
| | | output. An external pull-up resistor must be |
| | | connected to V_{CC}. Typical values for this |
| | | pull-up resistor are 4.7 kΩ (100 kHz) |
| | | and 1 kΩ (400 kHz). |
| SCL | Input | Schmitt trigger input pin for serial clock input |
| WP | Input | Input pin for hardware write protection control. If |
| | | this pin is tied to V_{CC}, the write function is |
| | | disabled to protect previously written data in the |
| | | entire memory. If this pin is tied to V_{SS}, the write |
| | | function is enabled. |
| V_{CC} | — | Single power supply. |

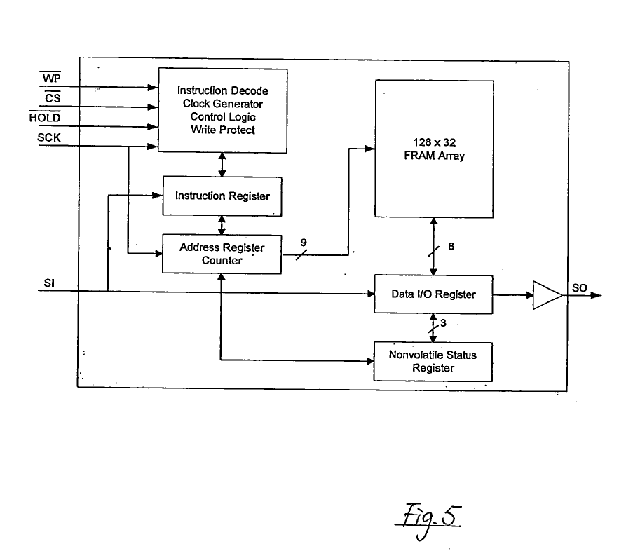

Another non-volatile memory which may be used in the present invention may be a 4 Kb-FRAM serial 3V memory manufactured and traded by Ramtron International Corporation of Colorado Springs, USA under serial number FM25CL04. A FRAM is non-volatile and performs reads and writes like a RAM. A block diagram of this non-volatile memory is shown in FIG. 5. Table 3 below gives the pin description of this non-volatile memory.

TABLE 3

| Pin Name | I/O | Description |
|---|---|---|
| /CS | Input | Chip Select: This active low input activates the device. |
| | | When high, the device enters low-power standby mode, |
| | | ignore other inputs, and all outputs are tri-stated. When low, |
| | | the device internally activates the SCK signal. A falling edge |
| | | on /CS must occur prior to every op-code. |
| /WP | Input | Write Protect: This active low pin prevents write operations to |
| | | the memory array or the status register. |
| /HOLD | Input | Hold: The /HOLD pin is used when the host CPU must |
| | | interrupt a memory operation for another task. When /HOLD |
| | | is low, the current operation is suspended. The device |
| | | ignores any transition on SCK or /CS. All transitions on |
| | | /HOLD must occur while SCK is low. |
| SCK | Input | Serial Clock: All I/O activity is synchronized to the serial clock. |
| | | Inputs are latched on the rising edge and outputs occur on the |
| | | falling edge. Since the device is static, the clock frequency |
| | | may be any value between 0 and 20 MHz and may be |
| | | interrupted at any time. |
| SI | Input | Serial Data Input: All data is input to the device on this pin. |
| | | The pin is sampled on the rising edge of SCK and is ignored |
| | | at other times. It should always be driven to a valid logic |
| | | level to meet IDD specifications. |
| | | *SI may be connected to SO for a single pin data interface. |
| SO | Output | Serial Data Output: This is the data output pin. It is driven |
| | | during a read and remains tri-stated at all other times |
| | | including when /HOLD is low. Data transitions are driven on the falling |
| | | edge of the serial clock. |
| | | *SO may be connected to SI for a single pin data interface. |
| VDD | Supply | Supply Voltage (2.7 V to 3.65 V) |
| VSS | Supply | Ground |

Unlike a serial EEPROM, a FRAM performs write operations at bus speed. No write delays are incurred. The next bus cycle may commence immediately without the need for data polling. It offers virtually unlimited write endurance, and exhibits much lower power consumption than an EEPROM. These capabilities allow a FRAM to be used in applications requiring frequent or rapid writes or low power operation.

Turning now to the manner of operation of the timepiece 100, the location data, say 12:00:01, of the analog display is placed on the non-volatile memory 110. The MCU 102 then reads this data from the non-volatile memory 110, and transfers such data to the volatile memory 106 for processing.

The MCU 102 sends a pulse signal to one of the poles 118a, 118b of the stepping motor 116. The motor 116 has two poles, 118a, 118b, which must be driven by the MCU 102, thus receive the pulses from the MCU 102, alternately. If, say, a pulse signal is sent to the pole 118a, the next pulse signal has to be sent to the pole 118b, and the next one has to be sent to the pole 118a, and so on. When the MCU 102 sends a pulse signal to a pole, e.g. the pole 118a, it will also measure its “width” by a respective I/O port, e.g. the port 120a. This measurement is taken at the pole of the step motor 116.

The “width” of a pulse signal/supply voltage is the time duration for which the voltage of the pulse signal is at or above a predetermined level. The measurement of the “width” of the supply voltage is “True” when the voltage of the pulse signal is at or above the predetermined level for at least the predetermined period of time; if not, the measurement will be “False”. The latter situation may arise when the supply voltage is low, or when any interruption occurs, e.g. when a battery is suddenly removed from the timepiece 100.

If the width measurement is “True”, the step motor 116 will advance to move the analog display. For example, the seconds hand will proceed by one step. The MCU 102 will immediately increase the data in the volatile memory 106 by 1, and so the data in the volatile memory 106 will be 12:00:02. The MCU 102 will also simultaneously update the data of the non-volatile memory 110 to 12:00:02 at bus speed. This means that the volatile memory 106, the non-volatile memory 110 and the analog display, which is driven by the stepping motor 116, are synchronized and updated at the same time, together with information of the polarity. The time-related data in the non-volatile memory 110 is thus now 12:00:02. The non-volatile memory 110 thus records the real time displayed by the analog display and reflects the true position of the analog display.

The MCU 102 then reads from the non-volatile memory 110 and sends the time-related data (which is now 12:00:02) to the volatile memory 106 for processing. The MCU 102 then sends a pulse signal to the pole 118b, and the width of the pulse signal is measured by the I/O port 120b. If the width measurement is “True”, the volatile memory 106 and the non-volatile memory 110 will be updated and synchronized at the same time, and the time-related data will then be 12:00:03. The pulse signal sent to the pole 118b will also drive the stepping motor 116 to move the analog display to show 12:00:03 accordingly. It can be seen that such an arrangement prevents uncertain polarity from happening after re-connection if there has been a power failure, or the battery is for any reason removed.

In case the width measurement is “False”, which is considered to be a negative result, the MCU 102 will not increase the data of the volatile memory 106 or that in the non-volatile memory 110. A “False” pulse width measurement may be caused by unexpected interruption or low power supply voltage. A pulse signal whose width measurement result is “False” can neither drive the stepping motor 116 to advance. Thus, even if a pulse signal is sent to the stepping motor 116, as its width measurement is “False”, the stepping motor 116 will not advance. By way of such an arrangement, if a pulse signal whose width measurement is “False” is sent, the MCU 102 will stop, leaving the data of the volatile memory 106 and the non-volatile memory 110 and the analog display synchronized but frozen as that right before the sending of the “False” pulse signal. If the power supply is disconnected, the data in the volatile memory 106 will vanish, but that in the non-volatile memory 110 will be intact. This is the case even if a good battery is for any reason removed from the timepiece 100.

Once power supply resumes, the MCU 102 will obtain time-related data from the non-volatile memory 110 and activate the radio signal receiver 108 to obtain time signal from the radio source, e.g. a satellite. Time signals may also be inputted into the timepiece 100 by a user operating the switches 112. The received time is then compared with the position data stored in the non-volatile memory 110. The MCU 102 will then rapidly output pulse signals to the stepping motor 116 to move the analog display to the position to display the correct current time.

It can be seen that in the arrangement according to the present invention, as the data in the volatile memory 106 and in particular in the non-volatile memory 110 are updated every second with the confirmation of the advance of the stepping motor 116, and a “port to pole” polarity assignment, the accuracy of the timepiece 100 is exact and such a timepiece can be used as a radio-controlled grade product.

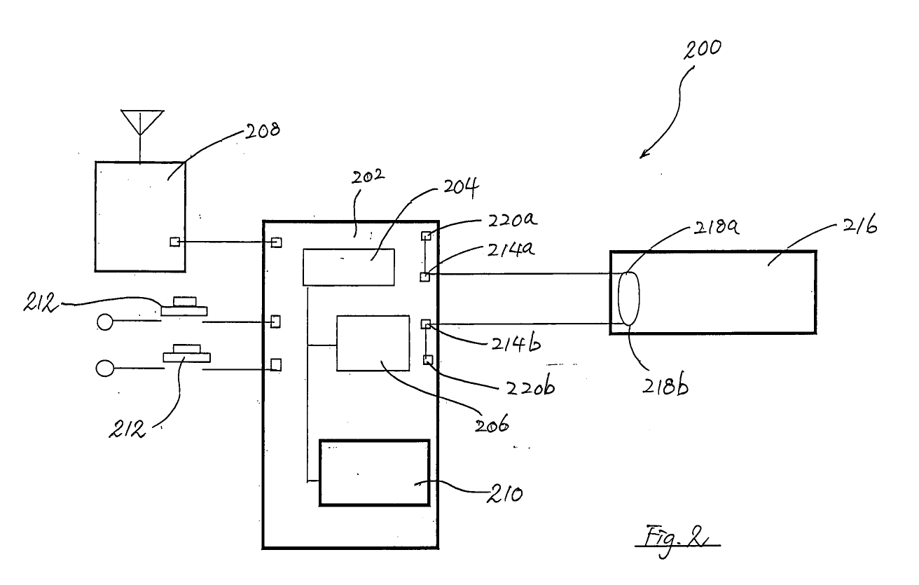

A block diagram of an electronic timepiece according to a second embodiment of the present invention is shown in FIG. 2, and generally designated as 200. The operation of the timepiece 200 is also controlled by a micro-controller (MCU) 202 with a processor 204 and a volatile memory 206, e.g. volatile RAM. The MCU 202 is connected with a radio signal receiver 208, which receives external time-related radio signal giving the accurate current time. Both the processor 204 and the volatile RAM 206 of the MCU 202 are connected with an internal non-volatile memory 210, e.g. an EEPROM or a ferroelectric random access memory (FRAM).

The MCU 202 is connected with two switches 212 operable to input time-related instructions into the timepiece 200 in place of signals received from an outside source by the signal receiver 208. The MCU 202 sends pulses, through motor drive I/O ports 214a, 214b, to poles 218a, 218b of a stepping motor 216 to drive a mechanical time display for displaying the time in an analog manner. The MCU 202 also includes two pulse width measurement I/O ports 220a, 220b for measuring the “width” of the pulses sent via the motor drive I/O ports 214a, 214b to the poles 218a, 218b of the stepping motor 216. In this arrangement, the pulse width measurement I/O ports 220a, 220b are connected with the respective motor drive I/O ports 214a, 214b internal of the MCU 202.

It should be understood that the above only illustrates examples whereby the present invention may be carried out, and that various modifications and/or alterations may be made thereto without departing from the spirit of the invention. For example, instead of measuring the “width” of the pulse signal, the micro-controller 102, 202 may monitor the supply voltage level of the battery, and arrange for the MCU 102, 202 to stop sending pulse signals to the motor 116, 216 if the voltage level drops below a predetermined level. The same synchronization result can thus also be achieved.

Alternatively, if the minimum operating voltage of the MCU 102, 202 is much higher than the motor driving voltage, then it is also not necessary to check the pulse width of the motor poles nor the supply voltage level. For instance, if the minimum operating voltage of the MCU 102, 202 is 2.4V, and the operation voltage of the stepping motor 116, 216 is 1.35V, when the supply voltage drops to 2.3V, the MCU 102, 202 will stop functioning before it can send out a pulse signal of a voltage lower than 1.35V to the stepping motor 116, 216. The same synchronization among the volatile memory 106, 206, the non-volatile memory 110, 210 and the analog display will be maintained.

As a further alternative, an external voltage regulator may be used for supplying power to the MCU 102, 202. The voltage applied to the MCU 102, 202 via the voltage regulator is adjusted to be just above the operating voltage of the MCU 102, 202. When the supply voltage from the voltage regulator drops to the minimum operating voltage of the MCU 102, 202, it will turn off the MCU 102, 202. Thus, instead of the MCU 102, 202 detecting and monitoring the supply voltage, it is the voltage regulator which acts as an external controller to control the voltage supply to the MCU 102, 202.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. An electric timepiece including:
a controlling device with at least a volatile memory adapted to be written with time-related data,
a non-volatile memory adapted to be written with time-related data, and
a motor operatively associated with an analog time display,
wherein said time-related data in said volatile memory and in said non-volatile memory are synchronized with each other, and wherein said controlling device is adapted to update said time-related data in said volatile memory and in said non-volatile memory simultaneously every second.

2. A timepiece according to claim 1 wherein said controlling device comprises a micro-controller.

3. A timepiece according to claim 1 further including a radio signal receiver adapted to receive radio signals relating to the current time from an outside source.

4. A timepiece according to claim 1 wherein said non-volatile memory is an EEPROM.

5. A timepiece according to claim 1 wherein said non-volatile memory is a FRAM.

6. A timepiece according to claim 1 wherein said non-volatile memory is external of said controlling device.

7. A timepiece according to claim 1 wherein said controlling device includes said non-volatile memory.

8. A timepiece according to claim 1 wherein said controlling device is adapted to send pulse signals to said motor for driving said analog time display.

9. A timepiece according to claim 8 wherein said controlling device includes at least one input/output (I/O) port for measuring the pulse width of the pulse signals sent to said motor.

10. A timepiece according to claim 9 wherein said controlling device is adapted to stop operation when the result of the measuring of the width of a pulse signal is negative.

11. A timepiece according to claim 1 wherein said controlling device monitors the supply voltage level of at least one battery powering said timepiece.

12. A timepiece according to claim 11 wherein said controlling device is adapted to stop operation when the supply voltage of said at least one battery falls below a predetermined level.

13. A timepiece according to claim 1 wherein the minimum operating voltage of the controlling device is higher than the voltage required for driving said motor.

14. A timepiece according to claim 1 further including a voltage regulator for supplying power to the controlling device.

15. A timepiece according to claim 14 wherein the voltage applied to the controlling device via the voltage regulator is just above the operating voltage of the controlling device.

16. A method of operating an electric timepiece including the steps of:
providing a controlling device with at least a volatile memory;
providing a non-volatile memory;
providing a motor operatively associated with an analog time display;
writing time-related data into said volatile memory;
writing time-related data into said non-volatile memory;
synchronizing said time-related data in said volatile memory and in said non-volatile memory; and
said controlling device updating said time-related data in said volatile memory and in said non-volatile memory simultaneously every second.

17. A method according to claim 16 wherein said controlling device comprises a micro-controller.

18. A method according to claim 16 further including a radio signal receiver adapted to receive radio signals relating to the current time from an outside source.

19. A method according to claim 16 wherein said non-volatile memory is an EEPROM.

20. A method according to claim 16 wherein said non-volatile memory is a FRAM.

21. A method according to claim 16 wherein said non-volatile memory is external of said controlling device.

22. A method according to claim 16 wherein said controlling device includes said non-volatile memory.

23. A method according to claim 16 wherein said controlling device sends pulse signals to said motor for driving said analog time display.

24. A method according to claim 23 wherein said controlling device includes at least one input/output (I/O) port which measures the pulse width of the pulse signals sent to said motor.

25. A method according to claim 24 wherein said controlling device stops operation when the result of the measuring of the width of a pulse signal is negative.

26. A method according to claim 16 wherein said controlling device monitors the supply voltage level of at least one battery powering said timepiece.

27. A method according to claim 26 wherein said controlling device stops operation when the supply voltage of said at least one battery falls below a predetermined level.

28. A method according to claim 16 wherein the minimum operating voltage of the controlling device is higher than the voltage required for driving said motor.

29. A method according to claim 16 further including a voltage regulator for supplying power to the controlling device.

30. A method according to claim 29 wherein the voltage applied to the controlling device via the voltage regulator is just above the operating voltage of the controlling device.
